(19) United States
(12) Patent Application Publication
(10) Pub. No.: US 2021/0374091 A1
(43) Pub. Date: Dec. 2, 2021

(54) METHOD AND SYSTEM FOR UPDATING FILES

(71) Applicant: Bruno SANGLE-FERRIERE, Paris (FR)

(72) Inventor: Bruno SANGLE-FERRIERE, Paris (FR)

(21) Appl. No.: 17/324,850

(22) Filed: May 19, 2021

(30) Foreign Application Priority Data
May 29, 2020 (FR) 2005707

(51) Int. Cl. G06F 16/11; G06F 21/32

(52) U.S. Cl. CPC G06F 16/116; G06F 21/32

(57) ABSTRACT

Method for transforming a first file on an electronic device into a second file able to be used on the device and/or on another electronic device. The conversion is performed by the device or by another apparatus to which the devices are able to connect on the basis of: the version of the first file, versions acceptable for the second file, as defined in a register or file of one of the devices, and conversion means that the devices or apparatus has In the event of one of the devices or apparatus connecting directly or indirectly to a server or to the apparatus having a more recent version of the first file, the first file is replaced with the more recent version prior to its transformation, the more recent version present on the server or the other apparatus being listed as being able to replace the first file.

### TECHNICAL FIELD

The present invention relates to a method and system for updating files.

### PRIOR ART

There are already some methods allowing files to be updated. For example, computer software and electronic devices are updated regularly when they connect to servers, via an Internet connection. In the absence of the possibility of connecting to a server, it is not possible to perform an update, even a partial one, without manual intervention. Moreover, when a file containing data, for example a word-processing file or a spreadsheet, has to be updated in order to be used by a different version of software, it is this same software that will convert the file upon an intervention by the user, and reverse transformation thereof will require another intervention by the user.

U.S. Pat. No. 7,065,588 B2 describes a method for converting heterogeneous documents using servers.

U.S. Pat. No. 5,251,314 A describes a method for transforming files, which creates a register of various successive transformations undergone by an initial document that is transformed into a final document, in order to be able to recreate the initial document from the final document.

US 2013/097670 discloses a server-implemented method for displaying and controlling access to image files in varying formats and sizes to different users, in which a web server receives a uniform resource locator (URL) containing identification of a requested image file along with one or more criteria and generates a transformed image file by modifying a stored version of the requested image file based on the one or more criteria. This method is server-based and requires an Internet connection to process the image file.

### DISCLOSURE OF THE INVENTION

There is a need to improve files used by electronic devices by allowing their editors to modify their content, without necessarily having to ask their users for authorization to do so and without having to systematically use a server. This is the case in particular in order to firstly allow editors to change the files over time, for example to modify the page layout thereof, but also so that they become compatible with various types of new electronic devices, these possibly being computers, connected watches, tablets or smartphones and the like, having expanded data storage means, higher-performance means for processing these data, or having display screens having better resolutions or better-quality loudspeakers. These may also be electronic devices having new functionalities such as new biometric checks, making it possible to connect to new display means such as video glasses, or that are compatible with new types of audio and video coding or having new higher-performance communication means, these updates not preventing said files from being able to be used, at the very least partially, by lower-performance apparatuses.

An update may also be useful for giving the files new functionalities, with a membership card possibly for example becoming a loyalty card for collecting points, or an electronic locking key being able to be modified so as to open a locker, an identity card being able to be used to note thereon information about an immunization record, or else to make them compatible with other systems operated by other operators if for example two clubs having different membership cards merge.

It may also be beneficial to be able to perform an update aimed at modifying information contained in files, in particular in order to add credit representing for example financial benefits, or points won in a lottery, or more simply correct a typographical error, for example.

In addition, in some cases, the file should be able to be used in a different version if it is ‘copied’ or ‘moved’ to an electronic device not having technical features required to store it or use it, and should therefore be transformed when it is transferred while still being able to be returned to its original state or to its last version later on if it is again transferred to an electronic device having better technical features.

Such a transformation may also be useful if said file is kept on one and the same electronic device but said electronic device itself has variable functionalities or capabilities, for example if its information storage location becomes saturated and requires the size of the files that it holds to be reduced, or by contrast if deleting other files from the electronic device ultimately allows it to store larger and better-quality files.

The invention aims to make it easier to transform a first file possibly containing multimedia or biometric information into a second file compatible with hardware, software or given file size and resolution limits in order in particular to better take advantage of the performance of the electronic devices and allow any useful update to the files that are used.

### SUMMARY OF THE INVENTION

The invention achieves this aim by virtue of a method for transforming a first file A present on an electronic device X, in particular containing multimedia or biometric information, into a second file B able to be used on the electronic device X and/or on another electronic device Y and compatible with hardware, software or given file size and resolution limits, in which method the conversion is performed by the electronic device X or by another apparatus D to which the devices X and Y are able to connect on the basis of:
the version of the file A,
versions acceptable for the file B as defined in a register or file of the electronic device X or Y, said information preferably originating from the electronic device Y when the file B is intended to be used on the electronic device Y,
conversion means that the electronic device X, Y or D has, wherein, in the event of one of the electronic devices X, Y or D connecting to a server S or another apparatus having a more recent version A′ of the file A, the file A is replaced with the file A′ prior to its transformation, the file A′ present on the server S or the other apparatus being listed as being able to replace the file A.

The connection of the electronic devices X, Y or D to the server S or to said other apparatus D may be direct or indirect.

The file A may be a document model, where applicable, said file A then containing elements able to be modified by users but that are not modified when the file A is transformed into file B.

The electronic devices X, Y and Dare not Web servers that may receive their requests from clients through the world wide web. The invention thus makes it possible to transform files without a connection to a server being essential. Hence, it is easier to change the files by virtue of the invention, and the transformation may take place where applicable when the electronic device X is connected to another electronic device Y, for example via a dual reader D capable of exchanging information with the devices X and Y and allowing information to be transferred from X to Y and vice versa, in particular a dual reader as described in patent U.S. Ser. No. 10/643,198.

Although the file A may be transformed into file B, preferably automatically, without connection to a server S, the invention also makes provision, when the device X or Y connects to a server S or to another apparatus containing the original version of the file A, that is, the most recent version of all versions of file A, or a more recent version A′ thereof, for the electronic device X or Y to be able to obtain, from the server or from this other apparatus, the original version of the file A or the most recent version A′ that is transformed or to be transformed, compatible with the electronic device X or Y that has to carry it or use it. In other words, a file that is degraded during a transformation in the absence of a connection to a server S may be returned, preferably automatically, to its original, non-degraded version A or updated upon connection to a server S or to another apparatus having an original version of the file A or a more recent version A′.

The file A is advantageously transformed on the basis of at least one preference criterion for the file or files B resulting from the transformation of the file A, and in particular satisfying a predefined optimization rule, this preference criterion or these preferences thus guiding the transformation. Using one or more preferences may make it possible to perform the conversion to the file B that best meets the capabilities of the electronic device that uses it and/or the preferences of the user as set in this device.

When the electronic device X is able to connect, in particular directly or indirectly, to another electronic device Y or to the abovementioned server, the method may comprise the step of importing, preferably automatically, means for transforming the file A, for example format conversion software, to the electronic device X during this connection.

When an electronic device is connected to the server, it is advantageously possible to replace any file A hosted by the device and that has either a quality worse than that of the original file A or a date D1 different from the date D1 of the last version of the file A with a file transformed from said original file A or one of its more recent versions.

The file A may contain biometric data for identifying at least one user, for example his fingerprints, and the modified version B may make it possible to identify this user with additional biometric data, for example his facial print, or biometric data of other individuals that are for example required for using the new version of said file.

The modified version B may also make it possible to display or use content of the file A with at least one new coding type.

The modified version B may also modify the presentation of information of the file A, for example the background picture of a document.

In some exemplary implementations, the method may have all or some of the following features, in particular make it possible:
to transform, preferably automatically, files without the presence of servers;
to update documents or formats by replacing them with another version originating from a server;
to transform modes of coding the information contained in the files; and/or
to optimize the coding of the information contained in the files.
The method is preferably implemented by:
Including, in the files A to be transformed and the transformed files B, information I1 about the version of the file and information I2 for calculating preferences for the modified versions B of the file;
Placing, on each electronic device able to use a transformed file, a file containing information A1 about the versions acceptable to this electronic device as well as information A2 about the conversion means that this electronic device has, in particular in terms of memory capacity and/or performance of the processor or available conversion software,
including, in each file A, an identifier 13 common to its various versions, said identifier making it possible in particular to associate, with the file A, its original file or replacement file, also called its reference file R,
By possessing said reference file R, preferably on a server S;
by allowing, on the server S, a reference file to be replaced with another one having the same identifier 13, the two versions being able to be distinguished from one another by the date D1 on which they were put into service on said server, included in the information I1 about the version of the file, the reference files prior to the new one preferably being kept on said server S;
by allowing, where applicable, the files to have elements able to be modified by users but that are not modified during transformations, the reference file then being a ‘format’ file, allowing electronic devices to display, to carry or to use said modifiable information.

The steps of converting the file A into file B may include the following steps:
i. the electronic device X taking part in the conversion reads the information I1 about the version of the file A, reads the information A1 from the file for the versions acceptable for the file B and reads the information A2 about the conversion means that it has,
ii. the electronic device X determines the version of the file B to which the file A should be converted, and
iii. the electronic device X converts the file A to file B.

The method may comprise the following steps between steps i and ii:
a) estimating, for each version that may be acceptable, values necessary to calculate the preferences I2, in particular the resolutions and the size of the various multimedia or biometric information contained in the file and the presence or absence of information that may influence, in particular embellish, the presentation of the various information,
b) calculating values necessary to calculate the acceptability criteria, starting with the versions judged to be preferable, until a version deemed to be acceptable is identified.

In some examples, the apparatus or the servers converting the file may have a means for signing the files electronically, this means involving for example calculating a hash of the file and encrypting said hash through the private key of a private/public key pair, or, as a variant, calculating the hash of the file mixed with a number that is kept secret, the hash then being encrypted by a single-use key that is kept secret, said secret number and said secret key still being accessible by an apparatus, such as a server that checks the signatures.

Where applicable, said apparatus or said servers may advantageously add to the file to be converted a signature of the file and its own identifier and, where applicable, the identifiers of the secret numbers and single-use keys that were used to calculate the signature.

When converting a file A into a file B, the electronic device C taking part in the conversion of the file A is preferably the one that carries the file A or the one that has to carry the file B or an intermediate electronic device, possibly being for example a dual reader D that instructs the transfer.

In one exemplary implementation, this electronic device C may, as mentioned above, read the information I1 about the version of the file A, the information A1 from the file for the versions acceptable for the file B and the information A2 about the conversion means that it has.

In one example, this device:
1. estimates, for each version that may be acceptable, the values necessary to calculate the preferences written in I2, such as for example the resolutions and the size of the various multimedia or biometric information contained in the file in the presence or absence of information that may embellish the presentation of the various information, after having possibly interrogated the server S containing the reference file R; if the electronic device does not have any means for converting information, this may be converted into blank or missing information. If the server S is not reachable, only versions not requiring the extraction of information from the server may be selected as acceptable;
2. calculates the values necessary for the acceptability criteria, such as for example the size of the file and the versions of the various software and hardware necessary to use it, preferably starting with the versions judged as being preferable, until a version deemed to be acceptable is identified;
3. determines the version of the file B into which the file A should be transformed;
4. converts the file A into selected file B, this conversion possibly requiring the server S to be interrogated if this was contacted in steps 2 or 3 and the version selected to generate the file B requires information that is also not available to the electronic device C.

As an alternative, steps 2 and 3 above may be combined; dichotomy is used for example to find the best combination of acceptable coding. Dichotomy is used for example between steps a) and b) above in order to find a coding and resolution combination that meets the acceptability criteria (A1) and that best meets the preferences (I2), a first calculation of the preferences and acceptability criteria being able to be performed for example using an intermediate value for each resolution and coding value of the various data of the file A, for example a value among the closest ones to the median, and then using intermediate values that are higher or equal if the last result is acceptable, or lower or equal values if not, and so on, until there is no further new calculation that can be performed.

If some multimedia or biometric information resolutions are more or less important than others, and are therefore more or less preferred, an importance grade for said information may be contained in the file I2. A reader for reading music files for example gives preference to the quality of the audio file over the quality of any associated images. It is also possible, using dichotomy, rather than adopting intermediate resolution values, to adopt extreme values that make it possible to achieve a better resolution for files judged to be important and a minimum resolution for files that are not important, and then to vary these choices for each following calculation, by reducing the resolutions of the important files if the result is not acceptable or by increasing the resolution of the less important files until the maximum acceptable resolutions of the second most important files are found, and so on, as far as the least important files.

If the server is disconnected from the electronic device C between steps 2 and 4, the procedure may be repeated starting from step 2, but without a connection to said server. Preferably, in order to benefit from better conversion capabilities available on a possible connected electronic device, if:
the file B computed at step 4 above by the electronic device has a size smaller than the size of the file A, for example more than 20% smaller, and the acceptable size for the converted file B is greater than this, for example by more than 20%, and
the file A is able to be converted by another electronic device D, for example by the electronic device on which it will be placed, if this has means necessary for converting the file A into acceptable versions, then this other electronic device D may perform steps 1 to 4 above if the resulting file is preferable to the converted file able to be generated by the electronic device C.

The information about the version that is used will preferably comprise a flag indicating whether said file is able to be used by the electronic device on which it is located. Specifically, in some exemplary implementations of the invention, a file may exist on an electronic device without it being able to be used by this device, even though it is able to be copied to another electronic device or updated upon connection to the server. A device not containing any video display means or any audio reader may for example accept files containing videos, texts or audio files.

In one exemplary implementation, an electronic device connected to the server replaces, preferably automatically, any file that it hosts and that has either a quality worse than that of the original file or a date D1 different from the date D1 of the original file with a file transformed from said original file, present on the server.

Preference Criterion/Criteria I2

A preference criterion in the sense of the invention is for example a sum of evaluation grades for the quality of the various information, each weighted by a coefficient of importance (MP) specific to the item of data. The evaluation of the quality of a file may be a grade depending on the type of coding that is used, multiplied by its size and, in the case of text, video or audio files, divided by the number of pages or minutes of video or sound coded by said file. A preference criterion may also take into account the work that is possibly necessary to transform the file, by adding to the added elements above, the evaluated time for transforming the various data, multiplied by a weighting coefficient. For example, if various types of audio coding are of comparable quality, are different but are all acceptable, the coding requiring the fewest transformations is, in one exemplary implementation of the invention, preferred over any other.

Information I1 about the version of the file

The information I1 about the version of the file includes for example all or some of the following information:
The date D1 of the version;
The coding of the main file: text, htm, html, pdf, etc. and its size;
The resolution of the images and their coding (JPEG, TIF, TIFF JPEG, PNG, etc.);
The resolution of the videos and their coding (avi, mpg2, mpg4, wmv, etc.);
The resolution of the audio files and their coding (VAV, FLAC, MP3, etc.);
The resolution of the other files and their coding (for example fingerprint files, face files and other biometric print files, including voiceprints).

Acceptable Versions

The information A1 about the acceptable versions includes for example all or some of the following information:
Maximum size of the file;
The coding of the main file: text, htm, html, pdf, etc. and its maximum size;
The maximum resolution of the images and their coding (JPEG, TIF, TIFF JPEG, PNG, etc.) and the maximum size of each file and the maximum size of the image files associated with the main file.
The maximum resolution of the videos and their coding (avi, mpg2, mpg4, wmv, etc.) and the maximum size of each file and the maximum size of the video files associated with the main file.
The maximum resolution of the audio files and their coding (VAV, FLAC, MP3, etc.) and the maximum size of each file and the maximum size of the audio files associated with the main file.
The resolution of the other files, their coding (for example fingerprint files, face files and other biometric print files, including voiceprints) and the maximum size of each file and the maximum size of the files of this type associated with the main file.
The maximum size of all of the files associated with the main file, including the main file itself.

Some sizes or resolutions of files or groups of files may however not be limited, especially if a maximum size of all of the files is set.

Recent Versions

An electronic device connected to the server may check, for any main file, whether a more recent version does not exist. If a more recent version exists, then the resolutions of the associated files may be chosen in particular in line with the preference and acceptability criteria used in the above example of a file transformation method; the transformed file may then be copied to said electronic device.

Possible Uses

The method according to the invention may be implemented, inter alia, in the following cases:
by a multimedia content provider, thus making it possible to improve the quality of photos, audio recordings or videos provided when the quality of the electronic devices reproducing the multimedia content improves, or after the user has acquired a better-quality electronic device, the modified version allowing content of the file A to be displayed or used with at least one new coding type;
in order to ensure that the file or file format used matches the new functionalities offered by the readers for reading said files, in particular when a new functionality appears, such as for example the possibility of using a new biometric check, the new format then offering the possibility of associating, with the main file, a file that allows the new type of biometric check to be used;
when the functionality of the file, in particular of the document, changes. For example, a club membership card may be associated with an electronic key for accessing facilities.

The method may be implemented in a system, in particular with a dual reader, making it possible to guarantee the authenticity of an electronic document, as described in abovementioned patent U.S. Ser. No. 10/643,198. The dual reader may convert the files or allow information to be exchanged between the devices that are connected thereto, even if these have different technical capabilities. The connection of the devices to the dual reader may be physical, through connectors, or be performed wirelessly and remotely, for example through a Bluetooth, Wi-Fi or NFC link or the like. The dual reader is advantageously also capable of connecting to a server.

### DETAILED DESCRIPTION

The invention may be better understood from reading the following detailed description of non-limiting exemplary implementations thereof, and from examining the appended drawing, in which:

### BRIEF DESCRIPTION OF THE DRAWINGS

FIG. 1 shows various elements of one example of a system according to the invention,

FIG. 2 shows steps of transforming a file,

FIG. 3 shows one example of using the method for modifying a file in order to add a new biometric means thereto,

FIG. 4 illustrates the use of the method for the sale of a video file, the definition quality of the image of which changes depending on the medium to which it is transferred, and

FIG. 5 shows one example of implementing the invention when the updated file contains modifiable information.

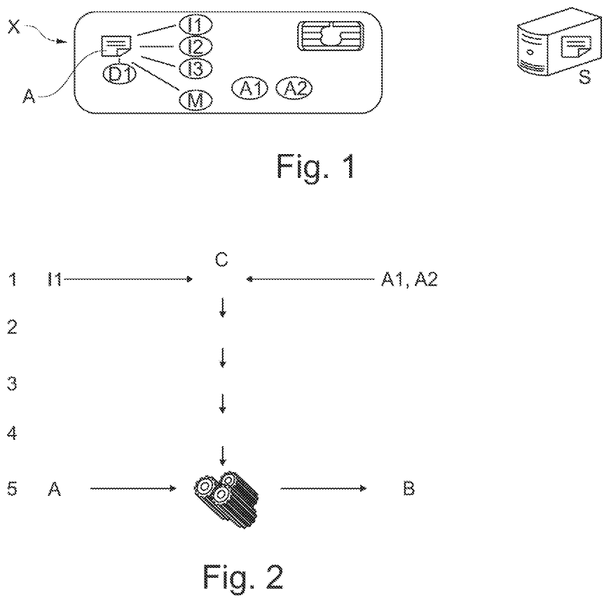

FIG. 1 schematically shows an electronic device X containing a file A that may be subject to an update within the scope of implementing the method according to the invention. An electronic device should be understood to mean any electronic device using at least one file capable of being updated through a direct or indirect connection to another apparatus or to a server, in particular any payment means or access fob, multimedia apparatus, connected apparatus, in particular a sensor, audio reader, video reader, mobile telephone, photography apparatus, camera, electronic key, connected watch, connected headset, vehicle, computer, etc.

The electronic device may include a processor, an internal memory, a human/machine interface, a remote communication circuit, for example RFID, Wi-Fi, Bluetooth, NFC, optical, etc., and/or one or more sensors that react to its environment.

The electronic device preferably has a screen for displaying information, in particular a touchscreen.

The electronic device may be a portable apparatus, for example a hand-held apparatus, having its own electric power supply, in particular a rechargeable battery.

A direct connection between two apparatuses denotes a connection in which the exchanged data do not transit via another apparatus; an indirect connection denotes a connection in which the exchanged data transit via another apparatus; where no specification is given, it should be considered that the connection may be direct or indirect. The direct connection may or may not be wireless.

The file A may contain, inter alia, the following information:
information I1 about the version of said file A,
information I2 about preferences for the various possible versions of the file A,
an identifier 13 of the file A, common to its various versions,
a date D1 of the version of the file A,
information M able to be modified by the user of the device, in particular during use of the file A.

The electronic device X advantageously additionally contains the following information placed in some of its registers:
information A1 about the versions, acceptable to said electronic device, of the file or files B resulting from the transformation of files A,
information A2 about the conversion means that the device X has for generating the transformed file B.

This device X may communicate with a server S via a remote connection, for example an Internet connection via a modem that may be included in a reader external to the device and connected thereto via contactors.

The server S may contain, where appropriate, at least one more recent version A′ of the file A. In this case, the file A may be replaced with the file A′ or with a file B transformed from said file A′.

FIG. 2 illustrates steps of implementing one example of a transformation method according to the invention.

In this figure, C denotes the electronic device that transforms the file A.

This may be the electronic device X described with reference to FIG. 1, which contains the file A, or an electronic device Y to which the file A is transferred, this file having for example been transferred from the device X to the device Y following a physical connection between the two, for example via a dual reader to which the two devices are able to connect, or via a direct physical or wireless connection between the two devices. The device C may also be the abovementioned dual reader.

In step 1, the electronic device C reads the information I1 about the version of the file A, reads the information A1 from the file A for the versions acceptable for the file B. The device C reads the information A2 about the conversion means that it has for performing the conversion.

The electronic device C then estimates, in step 2, for each version of the file B that may be acceptable, values necessary to calculate the preferences written in I2, such as for example the resolutions, coding and size of the various multimedia or biometric information contained in the file A and the presence or absence of information, such as logos or book illustrations that may influence, in particular embellish, the presentation of the various information, after having possibly interrogated the server S containing the reference file R in order to perform the calculations based on the reference file rather than the file A; if the electronic device C does not have any means for converting information, this may be converted into blank or missing information.

In step 3, the electronic device C calculates values necessary to calculate the acceptability criteria A1, preferably starting with the versions judged to be preferable, until a version deemed to be acceptable is identified.

In step 4, the electronic device C determines the version of the file B to be selected, before converting the file A or its original downloaded from the server into file B in step 5.

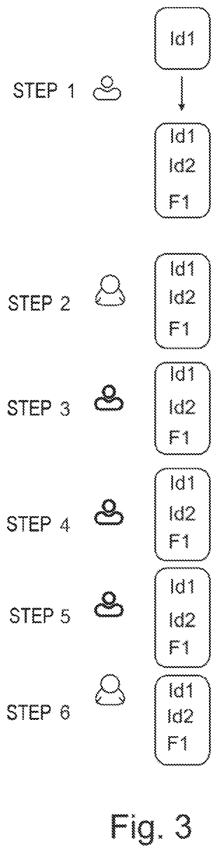

FIG. 3 illustrates steps of one example of a method applied to the transformation of a file for checking the fingerprints of an individual M1, so that this file may also allow said individual's face to be checked.

The file A contains biometric data for identifying at least one user, and the modified version A′ makes it possible to identify this user with other biometric data.

In this method, the fingerprints Id2 of a person accredited to supervise the biometric enrolment of the face have been included in the file A′ and are used so that this person is able to authorize the registration of the face of the individual. In the drawing, the reference signs Id1, Id2 and F1 are written in bold when they represent data that are provided, and in normal font when there is a register for said item of data without any item of information being contained therein. The drawing shows the interventions necessary from the individuals through black and white icons of busts respectively representing the user and the person accredited to supervise the enrolment.

In step 1, the individual M1 possesses information about his fingerprints Id1 in the electronic device.

In step 2, the individual connects the electronic device to the server S carrying a reference file A′, which is compatible with facial biometrics. This new file is therefore placed on the electronic device after having been converted into a file B, such that the file B is the preferable version of the conversions of the file A into files B compatible with the electronic device. The fingerprints Id1 of the individual M1 originating from the file A are introduced there, these data being “exchangeable”, that is to say that they are kept in spite of the conversion that is performed. The file A′ and therefore the file B also contain the fingerprints Id2 of a person who is able to accredit the entry of the faceprint of the individual M1.

In step 3, the person accredited to authorize the acquisition of the faceprint confirms his presence by scanning his fingerprint.

In step 4, the individual M1 for his part confirms his presence by scanning his fingerprint, and then he takes a photo of himself using the system in step 5. The system then acquires his faceprint F1.

In step 6, the individual scans his fingerprint for a last time, the accredited person also doing this again in step 7. This step allows the user and the accreditor to confirm the entry of the faceprint that has just been performed.

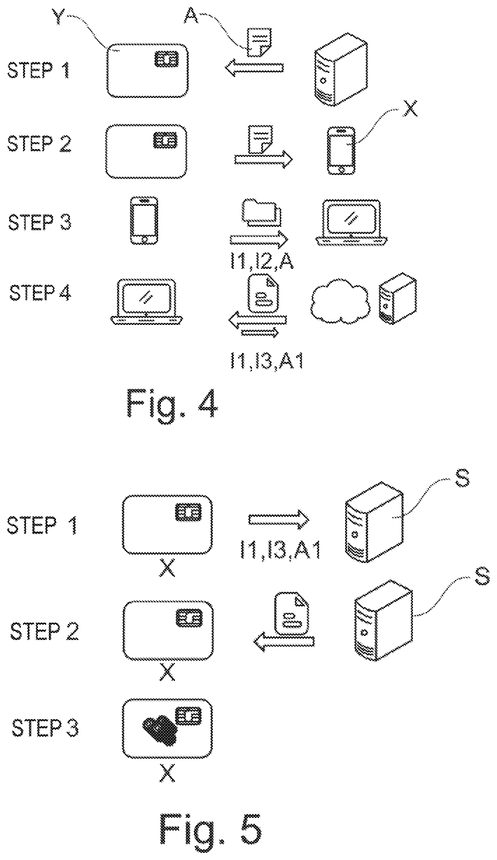

FIG. 4 shows, as another example of using the method according to the invention, the provision of a video file, the definition quality of the image of which may change, preferably automatically, depending on the medium to which it is transferred.

In step 1, a user downloads a high-definition (HD) video file A from a server S onto a device Y formed by his computer. This file also contains an image representing the display of the film contained in the video.

In step 2, the user transfers this video file A to a device X formed by his telephone. The information in the file A1 present on the device X shows that the memory available on the device X is not sufficient to accept the file, the size of which is written in the information I1 extracted from the file A. The file A is then, preferably automatically, when it is transferred to the device X, converted by the device X itself into a file B with standard video coding.

In step 3, the user retransfers the file B from his telephone to his computer, but the website that provided the video now has the video in a UHD format, in a file containing both the HD version and the UHD version of the same video. This file is for example listed on the server as being able to replace the HD file for an apparatus having read capabilities such as those of the apparatus Y. Prior to the reading of the file B on the computer, said computer interrogates the server by sending to it the identifier 13 and the information I1 from said file as well as the information A1 from the computer Y. The server responds by sending an ultra-high definition (UHD) version of the file, compatible with the computer, accompanied by an HD version if the computer has enough free space on its hard disk.

FIG. 5 illustrates another example of implementing the invention when the updated file contains modifiable information.

In step 1, the user connects his electronic device X to the server or to another electronic device S and sends to said device S the identifier 13 of the file A, information I1 and its information A1. In this example, the file A is out of date, and there is a more recent update A′ of this file on the device S. In particular, the device S has the register S1 of A′ in which it is listed that the file A′ is a more recent version of the file A.

In step 2, the electronic device X receives the file B converted from the new file A′ present on S.

In step 3, the electronic device X copies the variable information contained in the file A and inserts it into the new file at the locations that are reserved therefor, thereby generating a new file B. As an alternative, for example if the device X has limited computing means, the exchangeable information may be transmitted to the device S in step 1 so that, in step 2, the device S inserts said exchangeable information into the file B before transmitting said file B to the device X.

Needless to say, the invention is not limited to the examples that have just been described.

1. Method for transforming a first file A present on an electronic device X into a second file B able to be used on the electronic device X and/or on another electronic device Y and compatible with hardware, software or given file size and file resolution limits, in which method the conversion is performed by the electronic device X or by another apparatus D to which the devices X and Y are able to connect on the basis of:
the version of the file A,
versions acceptable for the file B as defined in a register or file of the electronic device X or Y,
conversion means that the electronic device X, Y or D has,
wherein, in the event of one of the electronic devices X, Y or D connecting directly or indirectly to a server S or to said other apparatus D, the server S or the other apparatus D having a more recent version A′ of the file A, the file A is replaced with a file A′ prior to its transformation, the file A′ present on the server or the other apparatus D being listed as being able to replace the file A.

2. Method according to claim 1, the file A being a document model, containing elements able to be modified by users but that are not modified when the file A is transformed into file B.

3. Method according to claim 1, wherein, when the device X or Y connects to a server S or to another apparatus containing the original version of the file A or a more recent version A′ thereof, the electronic device X or Y obtains the original version of the file A or the most recent version A′ that is transformed or to be transformed, compatible with the electronic device X or Y that has to carry it or use it.

4. Method according to claim 1, the transformation taking place on the basis of at least one preference criterion for the file or files B resulting from the transformation of the file A and satisfying a predefined optimization rule.

5. Method according to claim 1, the electronic device X being able to connect to another electronic device Y or to the server S, in which method means for transforming the file A are imported to the electronic device X during this connection.

6. Method according to claim 1, comprising the steps of:
a. Including, in the files A and B, information about the version of the file that is used and information for calculating preferences for the transformed files,
b. Placing, on each electronic device X able to use a transformed file B, a file containing information about the versions acceptable to said electronic device X as well as information about conversion means that this electronic device X has,
c. Including, in each file A, an identifier common to its various versions, said identifier making it possible to associate, with the file A, its original or replacement file, also called its reference file,
d. possessing said reference file on a server S;
e. allowing, on the server S, a reference file to be replaced with another one having the same identifier,
the steps of converting the file A into file B including the following steps:
i) the electronic device X taking part in the conversion reads the information about the version of the file A, reads the information from the file for the versions acceptable for the file B and reads the information about the conversion means that it has,
ii) the electronic device X determines the version of the file B to which the file A should be converted, and
iii) the electronic device X converts the file A to file B.

7. Method according to claim 6, comprising the following steps between steps i and ii:
a) estimating, for each version that may be acceptable, values necessary to calculate the preferences (I2),
b) calculating values necessary for the acceptability criteria, starting with the versions judged to be preferable, until a version deemed to be acceptable is identified.

8. Method according to claim 7, wherein dichotomy is used between steps a) and b) of claim 7 in order to find a coding and resolution combination that meets the acceptability criteria and that best meets the preferences.

9. Method according to claim 6, a first calculation of the preferences and acceptability criteria being performed using an intermediate value for each resolution and coding value of the various data of the file A, and then intermediate values that are higher or equal being used if the last result is acceptable, or lower or equal values if not, and so on, until there is no further new calculation that can be performed.

10. Method according to claim 6, wherein dichotomy is used to choose the highest resolution and coding values using a coefficient of importance, by adopting extreme values that make it possible to achieve a better resolution for files judged to be important according to the preferences and a minimum resolution for files that are not important, and then varying these choices for each following calculation, by reducing the resolution of the important files if the result is not acceptable according to the acceptability criteria or by increasing the resolution of the less important files until the maximum acceptable resolutions of the second most important files are found, and so on, as far as the least important files.

11. Method according to claim 1, the transformation being performed by a dual reader D.

12. Method according to claim 1, wherein, when an electronic device X connects to the server S, any file hosted by the device and that has either a quality worse than that of the original file A or a date different from the date of the original file A is replaced with a file B transformed from said original file A present on the server.

13. Method according to claim 1, the file A containing biometric data for identifying at least one user, and the modified version B making it possible to identify this user with other additional biometric data.

14. Method according to claim 1, the modified version making it possible to display or use content of the file A with at least one new coding type.

15. Method according to claim 1, the modified version B modifying the presentation of information of the file A.
